(19) United States
(12) Patent Application Publication
(10) Pub. No.: US 2024/0402660 A1
(43) Pub. Date: Dec. 5, 2024

(54) INDUSTRY FACILITY OPERATION CONTROL DEVICE BASED ON STANDARD OPERATION LEVEL EVALUATION, AND OPERATION METHOD FOR SAME

(71) Applicant: AINATION CO., LTD., Seoul (KR)

(72) Inventors: Jihoon KWAK, Seongnam-si, Gyeonggi-do (KR); Sangeun LEE, Seoul (KR); Geonho HWANG, Anyang-si, Gyeonggi-do (KR); Gwang Hyeon CHOI, Incheon (KR); Junho LEE, Seongnam-si, Gyeonggi-do (KR)

(21) Appl. No.: 18/565,498

(22) PCT Filed: Sep. 15, 2022
(86) PCT No.: PCT/KR2022/013776

§ 371 Date: Nov. 29, 2023

(30) Foreign Application Priority Data
Sep. 17, 2021 (KR) 10-2021-0125308

(51) Int. Cl. G05B 13/02

(52) U.S. Cl. CPC G05B 13/027

(57) ABSTRACT

Disclosed is a standard operating level assessment-based industrial equipment operation control device and operation method thereof.

According to one aspect of the invention, an industrial equipment operation control device includes a first neural network model-based feature prediction unit that receives time-series data of a target equipment using the first neural network model and derives data with non-time-series feature, and a second neural network model-based standard operation level prediction unit that receives non-time-series data of the target equipment and data and vectors with non-time-series feature derived from the first neural network model-based feature prediction unit, and predicts the standard operation level assessment using the second neural network model.

### TECHNICAL FIELD

This invention relates to an industrial equipment operation control device and its method of operation. More specifically, this invention relates to standard operating level assessment-based industrial equipment operation control device and operation method thereof.

### BACKGROUND ART

The content described in this section merely provides background information on the embodiments and does not constitute prior arts.

With the development of industrial processes, industrial control systems have evolved to remotely control hardware-based industrial equipments using computer systems.

In typical industrial control systems, most control operations are automatically carried out by remote terminals and programmable logic controllers (PLCs), and the control commands that an operator can issue are usually limited to basic task changes or management-level task adjustments.

The acquisition of data in industrial control systems begins with remote terminals or programmable logic controllers, involving tasks such as reading measurements required by the industrial control system or reporting the status of each piece of equipment. The data acquired in this way is converted at the control center into a form understandable by humans, so that the operator can make appropriate decisions for system management. The manager can then check the system's status from the converted data and issue control commands.

However, conventional control systems for controlling equipments only monitor simple numerical values of equipment output, compare these values against the threshold values, and determine only whether there is an error or an anomaly within a predetermined numerical range configured uniformly by equipment manufacturers for specific equipment or component and let the managing personnels be notified, without accurately identifying the condition or degree of aging of each piece of equipment or component over time.

Moreover, despite the differences in the optimized operating range and optimal amount of the load due to the aging of each component of these equipments or the manufacturing tolerances, the fact that a uniform system control scheme is applied to the equipments or components of the same kind makes an optimized operation practically impossible.

### DISCLOSURE

### Technical Problem

An embodiment of the present invention aims to provide a standard operation level assessment-based industrial equipment operation control device and its method of operation, by applying time-series and non-time-series data of an industrial equipment control system to a deep learning-based learning model for industrial equipment data according to a complex and sequential process to calculate the standard operation level assessment corresponding to each industrial equipment.

Additionally, an embodiment of the present invention, by calculating the assessed level based on the standard operation level assessment, aims to provide a standard operation level assessment-based industrial equipment operation control device and its operating method which can identify the standard operation level for each component of the equipment in real time, and optimizing the operation control of the equipment.

### Technical Solution

According to one aspect of the invention, an industrial equipment operation control device includes a first neural network model-based feature prediction unit that receives time-series data of a target equipment using the first neural network model and derives data with non-time-series feature, and a second neural network model-based standard operation level prediction unit that receives non-time-series data of the target equipment and data and vectors with non-time-series feature derived from the first neural network model-based feature prediction unit, and predicts the standard operation level assessment using the second neural network model. According to one aspect of the invention, the non-time-series data includes preprocessed data that combines category data and quantitative analysis data, each corresponding to the target equipment, after preprocessing.

According to one aspect of the invention, the categorical data includes vector data that has been preprocessed with one-hot encoding of classification information pre-configured corresponding to the target equipment.

According to one aspect of the invention, the quantitative analysis data includes at least one of the non-time-series data that has been normalized and preprocessed, corresponding to the operation time, age, weight, size, average daily power consumption, and rated output acquired in relation to the target equipment.

According to one aspect of the invention, the data with non-time-series feature are characterized as feature vectors derived from the time-series data of the target equipment being input into the first neural network model.

According to one aspect of the invention, the second neural network model is characterized by receiving data combining the data with the non-time-series feature and the non-time-series data of the target equipment.

According to one aspect of the invention, the industrial equipment operation control device further includes a equipment operation control unit that performs operation control of the target equipment based on the standard operation level assessment.

According to one aspect of the invention, the equipment operation control unit includes a standard operation level guide unit that outputs standard operation level guide information based on the standard operation level assessment, which includes at least one of the load range, operation voltage, or optimal output of the target equipment.

According to one aspect of the invention, the equipment operation control unit further includes an appropriate load range adjustment unit that varies the appropriate load range of the target equipment based on the standard operation level assessment.

According to one aspect of the invention, the equipment operation control unit further includes a target output configuration unit that varies the target output level of the target equipment based on the standard operation level assessment.

According to one aspect of the invention, the equipment operation control unit further includes a prediction variable analysis unit that analyzes how much a variable has influenced the outcome based on the standard operation level assessment.

According to one aspect of the invention, a method of operating an industrial equipment operation control device involves a first neural network model-based feature prediction process that uses the first neural network model to receive time-series data from the target equipment and derive data with non-time-series feature, and a second neural network model-based standard operation level prediction process that receives non-time-series data and vectors with non-time-series features derived from the first neural network model-based feature prediction process, and uses the second neural network model to predict the standard operation level assessment.

According to one aspect of the invention, the data with non-time-series feature is characterized as the feature vector derived from the time-series data of the target equipment being input into the first neural network model.

According to one aspect of the invention, the second neural network model is characterized by receiving data combining the data with non-time-series feature and the non-time-series data of the target equipment.

According to one aspect of the invention, the method of operating an industrial equipment operation control device further includes a control process that performs operation control of the target equipment based on the standard operation level assessment.

According to one aspect of the invention, the control process is characterized by outputting standard operation level guide information based on the standard operation level assessment, which includes at least one of the load range, operation voltage, or optimal output of the target equipment.

According to one aspect of the invention, the control process is characterized by varying the appropriate load range of the target equipment based on the standard operation level assessment or varying the target output level of the target equipment based on the standard operation level assessment.

According to one aspect of the invention, the control process is characterized by analyzing how much a variable has influenced the outcome based on the standard operation level assessment.

### Advantageous Effects

As described above, according to one aspect of the invention, it is advantageous to perform the prediction of the feature of time-series data based on the equipment data of the target equipment using the first neural network model, and using the second neural network model, based on the feature data of the time-series data and the non-time-series data extracted from the equipment data, to calculate the standard operation level assessment.

According to one aspect of the invention, using the calculated assessment level, it is possible to determine the standard operating level of the target equipment based on a complex neural network learning model, there is the advantage of enabling optimized operation configurations for industrial equipments.

Furthermore, according to one aspect of the invention, by calculating the assessed level based on the standard operation level assessment corresponding to each industrial equipment, there is the advantage of identifying the standard operation level for each equipment component in real-time and enabling optimized equipment operation control in response.

### DESCRIPTION OF DRAWINGS

FIG. 1 is a conceptual diagram that schematically illustrates the entire system according to an embodiment of the invention.

FIG. 2 is a diagram illustrating the configuration of an industrial equipment operation device according to the embodiment of the invention.

FIG. 3 is a diagram illustrating an example of the first neural network model-based feature prediction unit according to the embodiment of the invention.

FIG. 4 is a flowchart illustrating the method of operating an industrial equipment device according to the embodiment of the invention.

FIGS. 5 and 6 are diagrams for explaining a complex neural network learning process according to the embodiment of the invention.

FIGS. 7 and 8 are graphs for explaining the process for analyzing the importance of the predictor variables according to the embodiment of the invention.

FIGS. 9 and 10 are diagrams illustrating an exemplary process for the predictor variable analysis unit analyzing the cause according to the embodiment of the invention.

### MODE FOR INVENTION

The invention is subject to various modifications and can have various embodiments. Thus, specific embodiments may be shown in the drawings and described in detail. However, this is not intended to limit the invention to the particularly disclosed form, but rather, all modifications, equivalents, and alternatives are intended to be included within the spirit and scope of the invention. Similar reference numbers refer to similar elements while explaining each drawing.

The terms “first,” “second,” “A,” “B,” and the like may be used to describe various components, but the components should not be limited by these terms. These terms are only used to distinguish one component from another. For instance, a first component could be defined as a second component, and similarly, a second component could be defined as a first component, without departing from the scope of the present invention. The term “and/or” includes all combinations of one or more of the associated listed items.

When a component is said to be “connected” or “coupled” to another component, it can be directly connected or coupled to the other component, but it should be understood that there may be other component(s) interposed therebetween. On the other hand, if a component is said to be “directly connected” or “directly coupled” to another component, there is no other component intervening.

The terms used in the specifications are for the mere purpose of describing exemplary embodiments and are not intended to limit the invention. Singular forms are intended to include plural forms unless the context clearly indicates otherwise. It should be understood that the terms “comprising” or “having” in the specifications does not intend to exclude the presence or addition of the stated features, numbers, steps, operations, components, parts, or the combinations thereof in advance.

Unless defined otherwise, all terms used herein, including technical and scientific terms, have the same meaning as commonly understood by one of ordinary skill in the art to which this invention belongs.

Terms that are generally defined in dictionaries should be interpreted to have the meanings that are consistent with those meanings in the context of the relevant technology and should not be interpreted in an idealized or overly formal sense unless explicitly defined in the specifications. Additionally, each component, process, step, or method included in each embodiment of the invention can be shared within the scope that is technically not contradictory to each other.

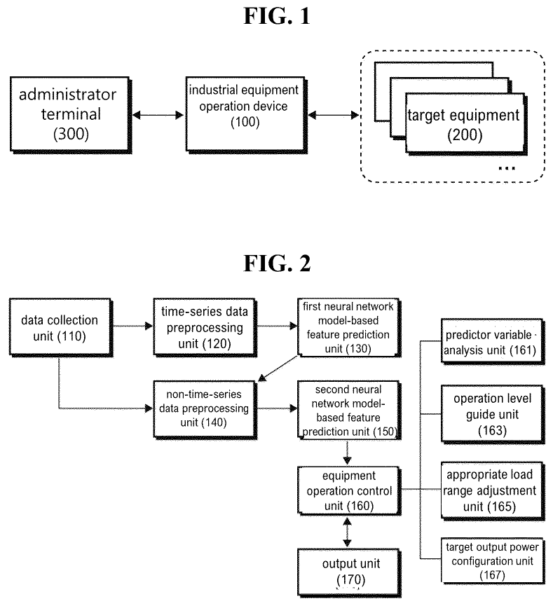

FIG. 1 is a conceptual diagram that schematically illustrates the entire system according to an embodiment of the invention.

The entire system according to an embodiment of the present invention may include an industrial equipment operation device (100), a target equipment (200), and an administrator terminal (300).

The administrator terminal (300) may be a device for measuring and controlling the status information of the target equipment (200) provided by the industrial equipment operation device (100), and may include various computing devices such as a program logic controller, a remote terminal, etc.

The industrial equipment operation device (100) is directly connected to the physical infrastructure of the target equipment (200), such as sensors or actuators installed in the process, and according to the control of the administrator terminal (300), transmits control signals. The industrial equipment operation device (100) collects output signals or sensor signals emitted from the target equipment (200) and converts them into computer-recognizable equipment data. Moreover, the industrial equipment operation device (100) transmits the control state information of the industrial equipment, obtained based on the equipment data, to the administrator terminal (300). Here, the state information may include measurement data, various kinds of status data, sensor data, etc. corresponding to the target equipment (200). Additionally, the industrial equipment operation device (100) can not only control actuators or relays of the device according to the control commands received from the administrator terminal (300), but also predict the standard operation level assessment of each target equipment (200) according to the embodiment of the present invention and optimize the operation of the target equipment (200) based on the predicted standard operation level assessment. Furthermore, the industrial equipment operation device (100) can also provide guide information to the administrator terminal (300).

For the above operations, the industrial equipment operation device (100), the target equipment (200), and the administrator terminal (300) can form a secured network, either wired or wireless, dependent on the industrial equipment, and perform communication with each other.

Here, the formed network can be implemented as any type of wired or wireless network, such as a Local Area Network (LAN), a Wide Area Network (WAN), a Value-Added Network (VAN), a Personal Area Network (PAN), a mobile radio-communication network, a satellite communication network, etc.

And the administrator terminal (300) can be any one of the individual devices such as a computer, a mobile phone, a smartphone, a smart pad, a laptop computer, a PDA (Personal Digital Assistants), or a PMP (Portable Media Player), or it can also be at least one of the multi-devices among public devices such as the kiosks or the stationary display devices installed at specific locations.

The industrial equipment operation device (100) differentiates the equipment data of the target equipment (200) as either time-series data or non-time-series data, and differently processes each.

The industrial equipment operation device (100) uses the first neural network model for the time-series data to extract feature vectors of the time-series data.

The industrial equipment operation device (100) can calculate a standard operation level assessment based on the extracted feature vectors of the time-series data and the non-time-series data from the equipment data, using the second neural network model.

Here, the standard operation level assessment is defined as a level or numerical value acquired for the individual target equipment (200) and indicates the category information about how long the equipments or the components corresponding to the individual target equipment (200) can withstand the load while providing normal output or efficiency. For example, if the standard operation level assessment of a specific target equipment (200) is relatively high, it can withstand higher load and provide normal output or efficiency for a longer duration compared to the equipment with an average standard operation level assessment.

Therefore, the industrial equipment operation device (100) can set a higher intensity load or a higher input range for target equipment (200) predicted to have a higher standard operation level assessment, and a lower intensity load or a lower input range for the target equipment (200) predicted to have a lower standard operation level assessment. Consequently, the industrial equipment operation device (100) can optimize the operation costs for the overall industrial equipments, reduce the rate of failures, and cut down the maintenance costs of the equipments and the devices.

For instance, the industrial equipment operation device (100) can compare the standard operation level assessment with the corresponding standard operation level table to perform optimization for the individual target equipment (200) by varying the operating time or operating cycle of the target equipment (200), adjusting the appropriate load range, or varying the target output range.

The composite neural network model described above can be applied to the process for calculating the standard operation level assessment in the industrial equipment operation device (100).

Here, the first and second neural network models in the composite neural network model applied to the process in the embodiment of the invention, can be implemented as any of a variety of learning models, such as the Convolutional Neural Network (CNN), the Recurrent Neural Network (RNN), the Long-Short Term Memory (LSTM), the Multi-Layer Perceptron (MLP), etc.

The first neural network model receives time-series data as input and extracts feature vectors. For example, the first neural network model can be implemented as a CNN model. Not only does the CNN model perform well in image recognition, but it also excels in comprehensively understanding the features of time-series data, from local to global aspects, by recognizing preprocessed time-series data as spatial data.

The second neural network model receives data combining the feature vector extracted from the time-series data with the preprocessed non-time-series data and predicts the standard operation level assessment. For example, the second neural network model can be constructed as a Multi-Layer Perceptron (MLP) neural network model, allowing the industrial equipment operation device (100) to predict the standard operation level assessment by comprehensively analyzing both the time-series and the non-time-series features of the target equipment (200).

Hereinafter, a more detailed description will be provided regarding the configuration and operation of the overall industrial equipment operation device (100) where such a composite neural network model is applied to the process.

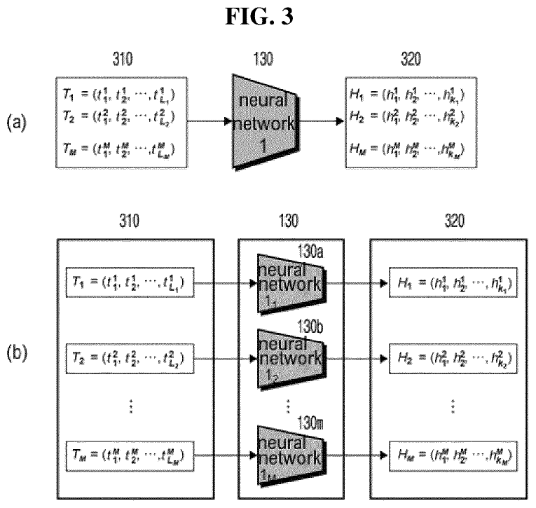

FIG. 2 is a diagram showing the configuration of the industrial equipment operation device according to the embodiment of the invention.

Referring to FIG. 2, the industrial equipment operation device (100) according to the embodiment of the invention includes a data collection unit (110), a time-series data preprocessing unit (120), a first neural network model-based feature prediction unit (130), a non-time-series data preprocessing unit (140), a second neural network model-based standard operation level prediction unit (150), an equipment operation control unit (160), and an output unit (170), where the equipment operation control unit (160) may further include a predictor variable analysis unit (161), an operation level guide unit (163), an appropriate load range adjustment unit (165), and a target output power configuration unit (167).

The data collection unit (110) collects the equipment data of the target equipment (200). Here, the equipment data may include time-series data and non-time-series data.

Time-series data is the signal data varying over time, which can be exemplified by the output signals of the target equipment (200), the measurement signals collected from the measuring devices implemented in the target equipment (200), or the sensor signals collected at the sensors of the target equipment (200), and may include time-series data that can be converted into digital data.

Non-time-series data may include the categorical data and the quantitative analysis data collected in relation to the target equipment (200).

The categorical data may include the category data contained in the packet data received from the target equipment (200), the category data pre-stored in relation to the identification information of the target equipment (200), or the classification information pre-configured in relation to the target equipment (200). For example, the categorical data of non-time-series data may include classification feature information that can be categorized by categorical keywords of the target equipment (200), such as the identification information, the name, the classification code, the category, the network information, etc.

Quantitative analysis data may include the quantitatively calculable scalar data, out of the information received from the target equipment (200) and processed. For example, quantitative analysis data may include quantitative feature information of the target equipment (200) that is numerically represented, such as the operation time information, the aging information, the weight information, the size information, the average daily power consumption information, the nominal output information, other specification information, etc.

With collecting data, the time-series data preprocessing unit (120) first preprocesses the time-series data to prepare it as input to the the first neural network model.

Here, the first neural network model is a pre-trained learning model for analyzing the feature of the time-series data, which receives the time-series data and derives a plurality of (hidden) feature vectors. It is trained so that the feature vectors could assess the standard operation level when inputted into the second neural network model along with the non-time-series data.

For example, assuming the first neural network model is a convolutional neural network model, the time-series data preprocessing unit (120) can handle missing data by applying the linear interpolation or the Lagrange interpolation to the corresponding time-series data output of the target equipment (200) and remove the noise on the data by applying the Median Filter or the Gaussian filter.

The first neural network model-based feature prediction unit (130) inputs the preprocessed time-series data into the first neural network model to extract feature vectors. As previously mentioned, the first neural network model generates the feature vectors that are used for prediction based on the time-series data input. The derived feature vectors do not contain time-series elements, unlike the input data. The first neural network model-based feature prediction unit (130) receives the time-series input and derives the non-time-series feature vectors.

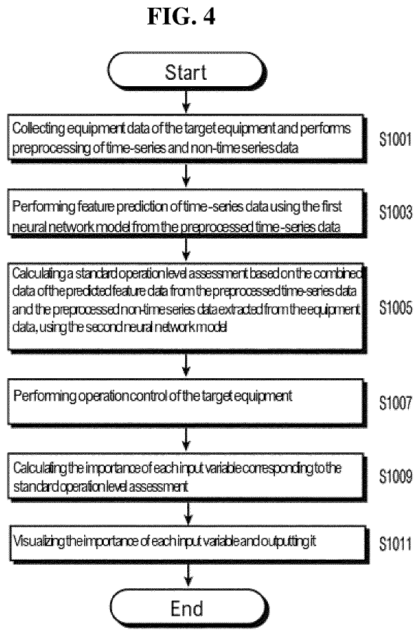

The structure of the first neural network model-based feature prediction unit (130) is illustrated in FIG. 3.

FIG. 3 is a diagram illustrating an example of the first neural network model-based feature prediction unit according to the embodiment of the invention.

Referring to FIG. 3a, M items of input data (T, 310), each of which has the dimension L1, L2, . . . , LM, can be fed to the first neural network model (130). Here, the first neural network model (130) is implemented singularly and possible to receive all of the M items as the input data. The first neural network model receives the input data and converts them into M items of hidden feature vectors (H, 320), each of which has the dimension K1, K2, . . . , KM. After passing through the first neural network model, the time-series data is transformed into non-time-series features.

Alternatively, referring to FIG. 3b, the first neural network model can be implemented as M neural network models (130a to 130m), each receiving the input data individually. Each neural network model receives a single input data and outputs hidden feature vector having dimension K1, K2, . . . , KM, respectively. Here, the size of the hidden feature vectors can vary.

Referring back to FIG. 2, the non-time-series data preprocessing unit (140) preprocesses the categorical data and quantitative analysis data of the non-time-series data, and transmits the combined data, where the preprocessed non-time-series data is combined with the hidden feature vectors outputted from the first neural network model-based feature prediction unit (130), to the second neural network model-based standard operation level prediction unit (150). As previously described, the second neural network model may include MLP neural network module and may be implemented by a classification model using the activation function like ReLU and the Softmax function, or by a regression model using the activation function like Sigmoid. Such standard operation level prediction unit (150) utilizing the second neural network model is configured to prepare the second neural network model to be trained in advance.

The second neural network model is a model that receives the combined data of the hidden feature vectors of the time-series data of the equipment data and the preprocessed non-time-series data as the input, and that predicts the standard operation level assessment calculated based on the assessed score or assessed rating that corresponds to the actual industrial equipment. Consequently, the non-time-series data preprocessing unit (140) preprocesses the hidden feature vectors of the time-series data of the equipment data and the preprocessed non-time-series data so that they can be fully inputted into the second neural network model-based standard operation level prediction unit (150) and processed. As previously mentioned, assuming that the hidden feature vectors of the time-series data have a total of

$$U = {\sum }_{i = 1}^{M} {K}_{i}$$

elements, and the non-time-series data is a vector with N elements, the non-time-series data preprocessing unit (140) combines both to create a vector with (U+N) components as the input data for the second neural network model.

For example, the categorical data out of the non-time-series data may be the vector data where pre-configured classification information is preprocessed in relation to the target equipment and may contain the vector data with V elements.

Also, the quantitative analysis data out of the non-time-series data may be the non-time-series vector data where at least one of the operating time, the aging, the weight, the size, the average daily power consumption, and the nominal output is preprocessed with normalization, which is acquired in relation to the target equipment, and may contain the vector data with (N-V) elements.

For example, the categorical data may be encoded, based on the classification codes or the categories, as [symbol] 1, 0 [symbol] for the sensor equipment, and the status classification codes may be encoded, based on the status of normal, malfunction, under repair, and repaired, as [symbol] 1, 0, 0, 0 [symbol] , [symbol] 0, 1, 0, 0 [symbol] , [symbol] 0, 0, 1, 0 [symbol] and [symbol] 0, 0, 0, 1 [symbol] , respectively. As an example, the sensor device under repair may be preprocessed by one-hot encoding as a categorical vector data of “ [symbol] 0, 1 [symbol] + [symbol] 0, 0, 1, 0 [symbol] = [symbol] 0, 1, 0, 0, 1, 0 [symbol] .”

Also, the quantitative analysis data may include data such as the power consumption, the operating time, the aging, the load, the size, the configured time, the configured output, etc., and may be normalized, preprocessed, and transformed into the vector data such as, for example, [symbol] 100, 900, 35, 70, 170, 120, 1000 [symbol] .

In this regard, the non-time-series data preprocessing unit (140) may finally be able to acquire the non-time-series vector data, [symbol] 100, 900, 35, 70, 170, 120, 1000, 0, 1, 0, 0, 1, 0 [symbol] , which is the combination of the quantitative analysis data and the categorical data, and further combination of this and the hidden feature vectors of the time-series data may be configured as the input data for the second neural network model-based standard operation level prediction unit (150).

The second neural network model-based standard operation level prediction unit (150) receives the preprocessed combined data as such and uses the learning model to predict the standard operation level assessment. As previously mentioned, the standard operation level assessment may be used as a measure for the normal output or efficiency of the individual target equipment (200), compared to the load or time, and, for example, it may be represented as a scalar value between 0 and 1, or the probabilities of the measuring classification classes.

The equipment operation control unit (160) may, based on the standard operation level assessment, control the operation of the individual target equipment (200), and may output the result of the control and the status information to the administrator terminal (300) via the output unit (170). Here, the output unit (170) may include a data interface or a network interface that transmits the result of the control and the status information, or its visualized data, to the administrator terminal (300).

More specifically, the equipment operation control unit (160) may include an operation level guide unit (163). The operation level guide unit (163) may output, based on the standard operation level assessment, the standard operation level guide information containing at least one of the load ranges, the operation voltage, and the optimal output power of the target equipment to the administrator terminal (300) via the output unit (170). This allows the administrator terminal (300) to perform remote control, to verify the standard operation level of the individual target equipment (200), and to enable the administrator terminal (300) to input commands for configuring the optimized operation range for each target equipment (200).

For example, an operator of the administrator terminal (300) may refer to the guide information and input the command information for varying at least one of the load ranges, the operation voltage, and the maximum output power, of the individual target equipment (200) based on the standard operation level assessment, into the equipment operation control unit (160).

Also, the equipment operation control unit (160) can include an appropriate load range adjustment unit (165) that adjusts the appropriate range of the load of the target equipment, based on the standard operation level assessment.

Additionally, the equipment operation control unit (160) may further include a target output power configuration unit (167) that adjusts the level of the target output power of the target equipment, based on the standard operation level assessment.

The appropriate load range adjustment unit (165) and the target output power configuration unit (167) may prepare and manage a standard operation level table containing the variable adjustment values compared to the pre-configured standard operation level assessment for the individual target equipment (200) in advance. The equipment operation control unit (160) may control the appropriate load range adjustment unit (165) and the target output power configuration unit (167), by comparing with the standard operation level table, to proceed with the equipment operation based on the optimized standard operation level assessment.

For instance, the administrator terminal (300) can input as configuration information a standard operation level assessment-based operation mode that decides whether to perform equipment operation based on the standard operation level assessment. In this case, the equipment operation control unit (160) can perform optimized automatic control that drives the appropriate load range adjustment unit (165) and the target output power configuration unit (167).

Meanwhile, the equipment operation control unit (160) may further include a predictor variable analysis unit (161) that calculates the importance of the individual input variable corresponding to the standard operation level assessment, based on the input and output data of the first neural network model-based feature prediction unit and the second neural network model-based standard operation level prediction unit.

The predictor variable analysis unit (161) may analyze, based on the predicted value of the standard operation level assessment, the influence of the variables. In predicting the standard operation level assessment, the probability-wise calculations are performed for various classes including a specific class to which the input data is predicted to be classified. For example, when assuming the input data is predicted to be classified to class C, the class C may have the highest probability, and any of the other classes A, B, etc., respectively, has lower probability that that. In this case, the predictor variable analysis unit (161) proceeds with the analysis with the assumption that only the predicted result (class) is acquired, to analyze the influence of the individual variable on the predicted result. In the above example, e to certain variables, assuming as if the input data were predicted to be class C with a probability of 1 (100%). In the above example, the predictor variable analysis unit (161) proceeds with the analysis assuming that the input data is predicted to be classified to the class C with a probability of 1 (100%).

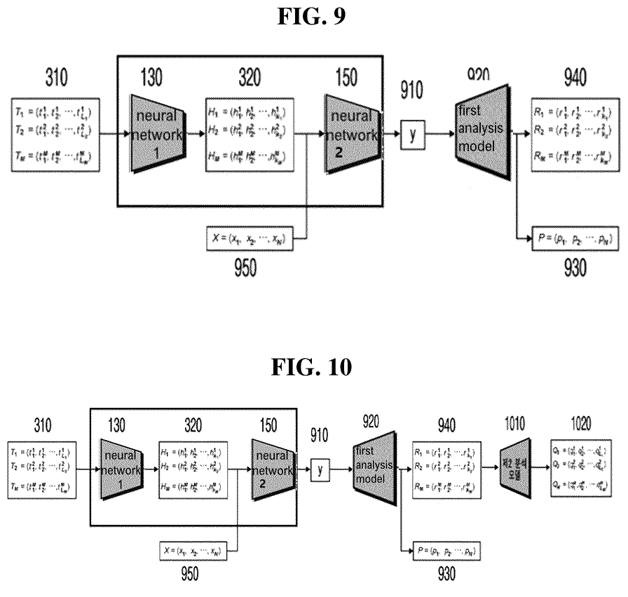

The predictor variable analysis unit (161) stores a learning model for analyzing the importance of variables and receives predicted results as input to analyze the importance of variables in each non-time series hidden feature vector and in non-time series input variables. The method of analysis by the predictor variable analysis unit (161) is illustrated in FIGS. 9 and 10.

FIGS. 9 and 10 are diagrams illustrating an exemplary process for the predictor variable analysis unit analyzing the cause according to the embodiment of the invention. Referring to FIG. 9, the predictor variable analysis unit (161) analyzes causes using a first analysis model (920).

The first analysis model (920) is a model that analyzes the extent to which each input data entered the second neural network model (150) affects the prediction of results by the second neural network model.

The first analysis model (920) can be implemented using DeepLIFT and may function as a model (function) that partially differentiates the second neural network model (function) with each input data. Since the input data entered the second neural network model (150) are non-time series hidden variables (320) and non-time series input variables (950), the first analysis model (920) can be a function that partially differentiates the second neural network model (function) for each of the non-time series hidden variables (320) and non-time series input variables (950). For instance, assuming the second neural network model as g, the first analysis model (920) could be

$$\frac{\partial g}{\partial {g}_{j}^{i}} ,$$

$$i = 1 , 2 , … , M ,$$

$$j = 1 , 2 , … , {K}_{i} , or$$

$$\frac{\partial g}{\partial {x}_{i}} ,$$

$$i = 1 , 2 , … , N .$$

Thus, by being implemented as a model that performs partial differentiation, the first analysis model (920) can determine the extent of influence each input data has in predicting the result.

At this point, the non-time series hidden variables can be major determinants affecting the prediction of results by the second neural network model. For example, if the first neural network model (130) is a CNN, and it's a model that determines what type of animal is present in an input image, the non-time series hidden variables could be major determinants such as the probability of a specific area being an eye, ear, paw, or tail, influencing the prediction of the result. However, the example is for the case where the learning model is a CNN and the input data is an image: if another model is used as the learning model, it might be difficult for a third party to immediately understand what the non-time series hidden variables signify. The first analysis model (920) can identify what each non-time series hidden variable is a determinant for by retroactively tracking the relationship between the influence of each non-time series hidden variable and the prediction result.

Meanwhile, the first analysis model (920) also undergoes the process for the influence of non-time series input variables and can analyze the impact of each non-time series input variable on the prediction of results.

Accordingly, the Equipment Operation Control Unit (160) can operate and control the target equipment (200) to resolve the cause based on the analysis results of the predictor variable analysis unit (161).

Meanwhile, the predictor variable analysis unit (161) can additionally use a second analysis model (1010) for analyzing causes. The second analysis model (1010) operates similarly to the first analysis model (920) and analyzes the extent to which each time-series input variable (310) affects the prediction results as it passes through the first and second neural network models. The second analysis model (1010) can be implemented using GradCAM or DeepLIFT and may function as a model (function) that partially differentiates the first neural network model (130) and the second neural network model (150) with each time-series input variable (310).

Consequently, the predictor variable analysis unit (161) can analyze not only the impact of each non-time series input variable (950) but also each time-series input variable (310) on the prediction of results.

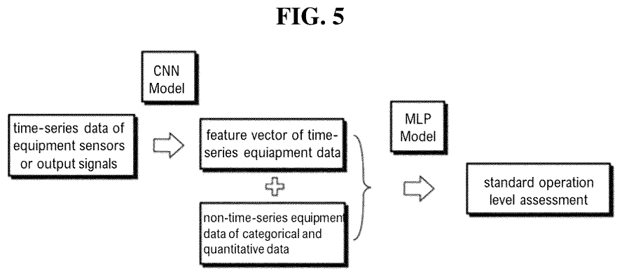

FIG. 4 is a flowchart illustrating the method of operating an industrial equipment device according to the embodiment of the invention.

Referring to FIG. 4, the industrial equipment operation device (100) according to an embodiment of the invention first collects equipment data of the target equipment and performs preprocessing of time-series and non-time series data (S1001).

The industrial equipment operation device (100) can use the time-series data preprocessing unit (120) to perform missing value processing and noise removal for time-series data extracted from the equipment data. The industrial equipment operation device (100) can use the non-time series data preprocessing unit (140) to one-hot encode categorical data extracted from the equipment data and to preprocess quantitative analysis data by combining and normalizing it into vector data.

The industrial equipment operation device (100) performs feature prediction of time-series data using the first neural network model from the preprocessed time-series data (S1003).

Here, the first neural network model, which may include a convolutional neural network model, can predict, and transform feature information of time-series data into vector information and output it.

The industrial equipment operation device (100) calculates a standard operation level assessment based on the combined data of the predicted feature data from the preprocessed time-series data and the preprocessed non-time series data extracted from the equipment data, using the second neural network model (S1005).

Here, the second neural network model, which may include an MLP (Multi-Layer Perceptron) neural network model, can be pre-trained to receive a combined vector of vectorized time-series data and preprocessed non-time series data, and predictively output a standard operation level assessment.

Based on the standard operation level assessment, the industrial equipment operation device (100) performs operation control of the target equipment (S1007).

The industrial equipment operation device (100) calculates the importance of each input variable corresponding to the standard operation level assessment (S1009).

The industrial equipment operation device (100) can visualize the importance of each input variable and output it through the output unit (170) to the manager terminal (300) (S1011).

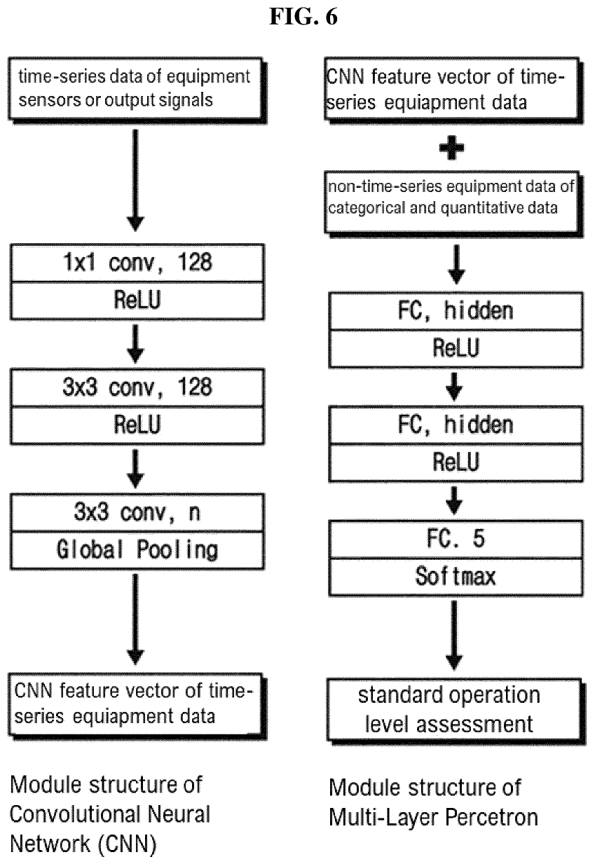

FIGS. 5 and 6 are diagrams for explaining a complex neural network learning process according to the embodiment of the invention.

Referring to FIGS. 5 and 6, the time-series data of equipment sensors or output signals according to an embodiment of the invention can be applied to the first neural network model: for example, it can pass through a convolutional neural network (CNN) model with a three-layer structure and ultimately produce an n×1 feature vector according to global pooling. The time-series feature vector can be used as an input value for a multi-layer perceptron (MLP) model when combined with non-time-series equipment data based on categorical and quantitative data.

Accordingly, all time-series and non-time-series features corresponding to the target equipment (200) can be formed as input vectors of the same dimension, and this can be configured to be processed by a 3-layer MLP, subsequently output as a standard operation level assessment.

According to this composite learning model configuration and processing, the standard operation level assessment can be predicted based on a cluster prediction model. The applicant has analyzed the classification accuracy of the standard operation level assessment according to an embodiment of the present invention and has achieved a 88% accuracy in confirming the alignment between actual prediction values and the operation level assessments of the industrial equipments assessed by the operator.

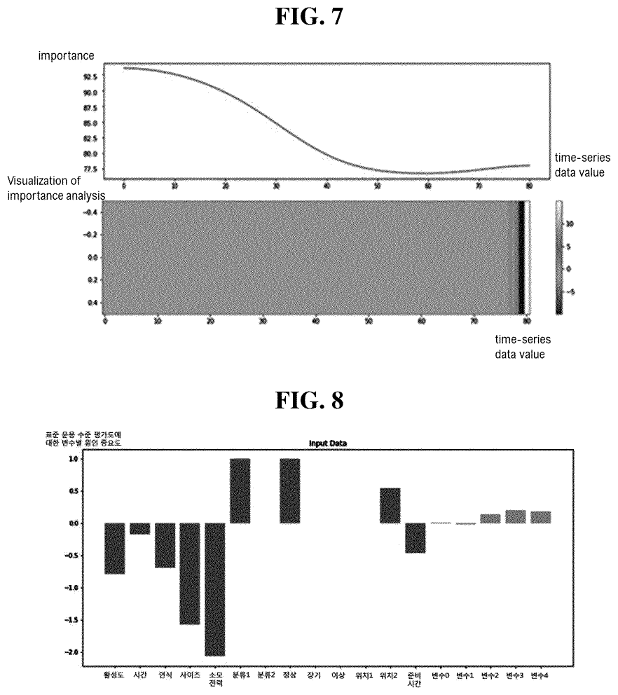

FIGS. 7 and 8 are graphs for explaining the process for analyzing the importance of the predictor variables according to the embodiment of the invention.

Referring to FIGS. 7 and 8, changes in the standard operation level assessment according to an embodiment of the present invention can vary based on changes in the input time-series data values as shown in FIG. 7 and based on non-time-series data values as shown in FIG. 8, and the importance of each variable can be quantitatively analyzed. Such importance analysis can employ well-known deep learning model importance analysis methods, such as the DeepLIFT method, or AI interpretation frameworks like LIME, Shapley, Skater, What-If Tool, Activation Atlases, or InterpretML.

Consequently, analysis data like that shown in FIGS. 7 and 8 can pass through an output unit (170) and be output to an administrator terminal (300), enabling visual confirmation of causal importance by input variable and time-series data.

FIG. 4 presents each process executed sequentially, but this is merely an illustration of the technological concept of one embodiment of the present invention. In other words, for those skilled in the art to which the present embodiment belongs, it is possible to modify and change various aspects within the scope without departing from the essential characteristics of the present embodiment, including altering the order described in each drawing and executing one or more processes in parallel. Therefore, FIG. 4 is not limited to a time-series order.

Furthermore, the processes described in FIG. 4 can be implemented as code that a computer can read on a computer-readable medium. A computer-readable medium encompasses all types of recording media on which data readable by a computer system is stored. In other words, a computer-readable medium includes magnetic storage media (e.g., ROM, floppy disk, hard disk, etc.) and optical reading media (e.g., CD-ROM, DVD, etc.), and can be distributed on a computer system connected via a network, enabling the code readable by a computer to be stored and executed in a distributed manner.

The foregoing description is merely an illustration of the technological concept of one embodiment of the present invention, and various modifications and changes can be made within the scope without departing from the essential characteristics of the present embodiment for those skilled in the art to which the present embodiment belongs. Therefore, the scope of protection of the present embodiment should be interpreted according to the claims below, and all technological concepts within the scope of the claims should be included in the scope of the present embodiment.

### CROSS-REFERENCE TO RELATED APPLICATION

This patent application claims priority under 35 U.S.C § 119 (a) to Korean Patent Application No. 10-2021-0125308 filed on Sep. 17, 2021, and all contents thereof are incorporated herein by reference. Additionally, this patent application claims priority for the same reasons in countries other than the United States, and all contents thereof are incorporated herein by reference.

1. An industrial equipment operation control device comprising:
a first neural network model-based feature prediction unit that receives time-series data of a target equipment using the first neural network model and derives data with non-time-series feature; and
a second neural network model-based standard operation level prediction unit that receives non-time-series data of the target equipment and data and vectors with non-time-series feature derived from the first neural network model-based feature prediction unit, and predicts the standard operation level assessment using the second neural network model.

2. The device of claim 1, wherein the non-time-series data includes preprocessed data that combines category data and quantitative analysis data, each corresponding to the target equipment, after preprocessing.

3. The device of claim 2, wherein the categorical data includes vector data that has been preprocessed with one-hot encoding of classification information pre-configured corresponding to the target equipment.

4. The device of claim 2, wherein the quantitative analysis data includes at least one of the non-time-series data that has been normalized and preprocessed, corresponding to the operation time, age, weight, size, average daily power consumption, and rated output acquired in relation to the target equipment.

5. The device of claim 1, wherein the data with non-time-series feature are characterized as feature vectors derived from the time-series data of the target equipment being input into the first neural network model.

6. The device of claim 5, wherein the second neural network model is characterized by receiving data combining the data with the non-time-series feature and the non-time-series data of the target equipment.

7. The device of claim 1, wherein the industrial equipment operation control device further includes an equipment operation control unit that performs operation control of the target equipment based on the standard operation level assessment.

8. The device of claim 7, wherein the equipment operation control unit includes a standard operation level guide unit that outputs standard operation level guide information based on the standard operation level assessment, which includes at least one of the load range, operation voltage, or optimal output of the target equipment.

9. The device of claim 7, wherein the equipment operation control unit further includes an appropriate load range adjustment unit that varies the appropriate load range of the target equipment based on the standard operation level assessment.

10. The device of claim 7, wherein the equipment operation control unit further includes a target output configuration unit that varies the target output level of the target equipment based on the standard operation level assessment.

11. The device of claim 7, wherein the equipment operation control unit further includes a predictor variable analysis unit that analyzes how much a variable has influenced the outcome based on the standard operation level assessment.

12. A method of operating an industrial equipment operation control device comprising:
receiving, by a first neural network model-based feature prediction process that uses the first neural network model, a time-series data from the target equipment, and deriving data with a non-time-series feature; and
receiving the non-time-series data and vectors with non-time-series features derived from the first neural network model-based feature prediction process, and predicting, by a second neural network model-based standard operation level prediction process, the standard operation level assessment using the second neural network model.

13. The method of claim 12, wherein the data with non-time-series feature is characterized as the feature vector derived from the time-series data of the target equipment being input into the first neural network model.

14. The method of claim 13, wherein the second neural network model is characterized by receiving data combining the data with non-time-series feature and the non-time-series data of the target equipment.

15. The method of claim 12, further comprising:
a control process that performs operation control of the target equipment based on the standard operation level assessment.

16. The method of claim 15, wherein the control process is characterized by outputting standard operation level guide information based on the standard operation level assessment, which includes at least one of the load range, operation voltage, or optimal output of the target equipment.

17. The method of claim 15, wherein the control process is characterized by:
varying the appropriate load range of the target equipment based on the standard operation level assessment; or
varying the target output level of the target equipment based on the standard operation level assessment.

18. The method of claim 15, wherein the control process is characterized by:
analyzing how much a variable has influenced the outcome based on the standard operation level assessment.
